(19) United States
(12) Patent Application Publication
(10) Pub. No.: US 2015/0345050 A1
(43) Pub. Date: Dec. 3, 2015

(54) VIBRATIONAL SPREADER BAR FOR SPREADING UNIDIRECTIONAL YARNS

(71) Applicants: TEIJIN ARAMID B.V., Arnhem (NL); BARRDAY INC., Charlotte, NC (US)

(72) Inventors: Jason Leroy Wilson, Charlotte, NC (US); Gary Matthew Towery, Charlotte, NC (US)

(21) Appl. No.: 14/653,311

(22) PCT Filed: Dec. 20, 2013
(86) PCT No.: PCT/US13/76923

§ 371 Date: Jun. 18, 2015

Related U.S. Application Data
(60) Provisional application No. 61/739,809, filed on Dec. 20, 2012.

(51) Int. Cl. D02J 1/18; B05C 3/05; B05D 1/18; B05C 1/08

(52) U.S. Cl. CPC D02J 1/18; B05C 1/08; B05C 3/05; B05D 1/18

(57) ABSTRACT

A fiber processing system includes a fiber spreader that has a spreader bar that extends in a lengthwise direction between first and second ends. The spreader bar carries at least one radiused surface between the first and second ends. At least one mechanical vibration device is operable to vibrate the spreader bar. The at least one mechanical vibration device is connected to input mechanical vibration into the spreader bar at a location between the first and second ends. A method for spreading at least one fiber bundle includes moving at least one tensioned fiber bundle over a radiused surface of the spreader bar. During the moving, mechanical vibration is input into the spreader bar at a location between the first and second ends, to transversely spread and flatten the at least one tensioned fiber bundle.

### CROSS REFERENCE TO RELATED APPLICATION

This application claims priority to U.S. Provisional Application No. 61/739,809, which was filed Dec. 20, 2012 and is incorporated herein by reference.

### FIELD OF THE DISCLOSURE

This disclosure relates to a method and system for spreading fiber bundles that are used in fiber-reinforced composites.

### BACKGROUND

Fiber bundles, each having of a plurality of filaments, are known and used for fabricating anti-ballistic fiber-reinforced layers and laminates. The bundles can be spread in a direction perpendicular to the filament direction by tensioning the bundle over a roller or group of rollers. However, the tensioning can break a portion of the fibers and thereby reduce the anti-ballistic properties of the layer or laminate.

### SUMMARY

A fiber processing system according to an example of the present disclosure includes a fiber spreader having a spreader bar that extends in a lengthwise direction between first and second ends. The spreader bar carries at least one radiused surface between the first and second ends, and at least one mechanical vibration device operable to vibrate the spreader bar. The at least one mechanical vibration device is connected to input mechanical vibration into the spreader bar at a location between the first and second ends.

In a further embodiment of any of the foregoing embodiments, at least one mechanical vibration device consists of a single mechanical vibration device.

In a further embodiment of any of the foregoing embodiments, at least one mechanical vibration device consists of a single mechanical vibration device that is connected to input mechanical vibration into the spreader bar at a mid-point of the spreader bar between the first and second ends.

In a further embodiment of any of the foregoing embodiments, at least one mechanical vibration device includes a plurality of distinct mechanical vibration devices.

In a further embodiment of any of the foregoing embodiments, at least one mechanical vibration device includes a plurality of distinct mechanical vibration devices connected to input mechanical vibration into the spreader bar at different, discrete locations along the spreader bar.

In a further embodiment of any of the foregoing embodiments, at least the spreader bar is submerged in a resin bath, and the at least one radiused surface has a span, S, of one meter or more.

In a further embodiment of any of the foregoing embodiments, the resin bath has a viscosity of 300-1200 centipoise.

A method for spreading at least one fiber bundle according to an example of the present disclosure includes moving at least one tensioned fiber bundle over a radiused surface of a spreader bar that extends in a lengthwise direction between first and second ends and during the moving, inputting mechanical vibration into the spreader bar at a location between the first and second ends, to transversely spread and flatten the at least one tensioned fiber bundle.

A further embodiment of any of the foregoing embodiments includes inputting the mechanical vibration into the spreader bar at a single, exclusive location between the first and second ends.

In a further embodiment of any of the foregoing embodiments, the single, exclusive location is at a mid-point between the first and second ends.

A further embodiment of any of the foregoing embodiments includes inputting the mechanical vibration into the spreader bar at a mid-point between the first and second ends.

A further embodiment of any of the foregoing embodiments includes inputting the mechanical vibration into the spreader bar at multiple locations along the spreader bar.

In a further embodiment of any of the foregoing embodiments, multiple locations along the spreader bar exclude a mid-point of the spreader bar.

In a further embodiment of any of the foregoing embodiments, multiple locations along the spreader bar are symmetric with respect to a mid-point of the spreader bar.

A further embodiment of any of the foregoing embodiments includes inputting the mechanical vibration into the spreader bar to establish a spreader bar vibration frequency of at least 5000 Hz and a spreader bar force of vibration of at least 300 pounds.

A further embodiment of any of the foregoing embodiments includes inputting the mechanical vibration into the spreader bar and establishing a spreader bar vibration frequency of at least 7000 Hz and a spreader bar force of vibration of at least 300 pounds.

In a further embodiment of any of the foregoing embodiments, moving of the at least one tensioned fiber bundle over the radiused surface includes moving a web of side-by-side fiber bundles over a span, S, across the radiused surface.

In a further embodiment of any of the foregoing embodiments, span, S, is one meter or more, and the radiused surface is submerged in a resin bath.

In a further embodiment of any of the foregoing embodiments, resin bath has a viscosity of 300-1200 centipoise.

### DESCRIPTION OF THE FIGURES

The various features and advantages of the present disclosure will become apparent to those skilled in the art from the following detailed description. The drawings that accompany the detailed description can be briefly described as follows.

FIG. 1 illustrates an example fiber processing system.

FIG. 2 illustrates an example spreader bar and mechanical vibration device located a mid-point of the spreader bar.

FIG. 3 illustrates another example spreader bar with three mechanical vibration devices.

FIG. 4 illustrates another example spreader bar with two mechanical vibration devices.

### DETAILED DESCRIPTION

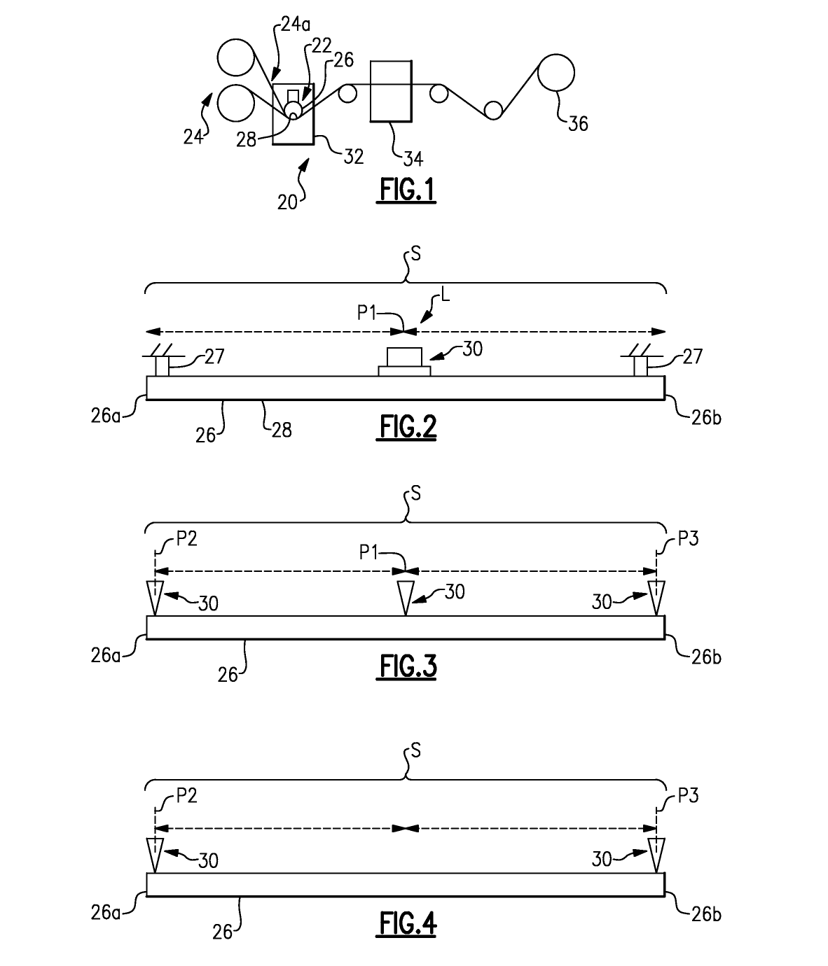

FIG. 1 illustrates an example fiber processing system 20 for fabricating an anti-ballisitc unidirectional, fiber-reinforced composite sheet, also known as a fiber monolayer, from a plurality of fiber bundles. The fiber bundles each include a plurality of filaments. Several monolayers can be laminated together to, for example, fabricate multi-layer, anti-ballistic laminates, such as 2-ply 0°/90° or 4-ply 0°/90°/0°/90° configurations with or without polymer films laminated on outer surfaces. In this regard, the fiber bundles can be anti-ballistic fiber bundles, such as aramid or para-aramid fiber bundles.

In anti-ballistic end-uses, low areal density of a monolayer and multi-layer laminate, as well as layer-to-layer standard deviation in weight, are critical to reducing weight and improving performance. To reduce fiber areal density, obtain more uniform distribution of the filaments, and obtain lower standard deviation in weight in a monolayer, the fiber bundles are spread during processing using mechanical vibration. In this regard, the fiber processing system 20 includes at least a fiber spreader 22 that facilitates spreading and flattening of the fiber bundles. For the purpose of description, the fiber spreader 22 is described with reference to the example shown in FIG. 1; however, it is to be understood that the fiber spreader 22 and arrangement of the fiber processing system 20 is not limited to the illustrated example and that other fiber processing systems will also benefit from the examples herein.

In this example, the fiber processing system 20 is configured to fabricate a monolayer as discussed above. For example, the monolayer can include unidirectional fiber bundles, such as aramid or para-aramid fiber bundles, embedded in a polymeric matrix. For example, the polymeric matrix can be PRINLIN B7137 HV, an elastomeric block copolymer. For spread para-aramid fiber bundles, the fiber areal density in the monolayer can be less than 50g/m², with a dry resin content between 10% to 20%, by weight, such that the total areal density of the monolayer is less than 60 g/m². As can be appreciated, the fiber processing system 20 can be configured to process other types of anti-ballistic fiber bundles and areal densities.

The fiber processing system 20 includes fiber bundle creels 24 from which fiber bundles 24a are drawn to the fiber spreader 22. The fiber spreader 22 includes a spreader bar 26, as also shown in FIG. 2, which extends in a lengthwise direction over a span S between first and second ends 26a/26b. The span S is relatively long and can be greater than or equal to one meter, approximately 1.3 meters, approximately 1.5 meters, or between one and two meters, as will be further discussed below. In this example, the spreader bar 26 is fixed on one or more mounts 27. The mounts 27 can be rigid mounts or compliant mounts. Compliant mounts can include, for example, rubber mounts. The spreader bar 26 carries at least one radiused surface 28 between the first and second ends 26a/26b. The fiber bundles 24a are tensioned and moved or drawn over the at least one radiused surface 28 in a parallel web arrangement with the fiber bundles 24a being side-by-side across the full or substantially full span S of the spreader bar 26, although some fiber bundles 24a may overlap.

At least one mechanical vibration device 30 is operable to vibrate the spreader bar 26, for example, at a controlled, preset frequency. For example, the vibration can be horizontal (along the length of spreader bar 26), vertical (perpendicular to the spreader bar 26), or a combination thereof. The mechanical vibration device 30 can be pneumatic, electro-magnetic, or another type of vibration device adapted to input vibration into the spreader bar 26. The mechanical vibration device 30 is connected to input mechanical vibration into the spreader bar 26 at a location, represented at L, between the first and second ends 26a/26b.

In this example, the fiber spreader 22, or at least the spreader bar 26 or radiused surface 28, is submerged in a resin bath 32 and the spreading thus occurs with the fiber bundles 24a submerged in the resin bath 32. The resin bath serves to impregnate the fiber bundles 24a with a matrix resin material at 32, which is then cured in heater 34. The monolayer sheet is taken up on storage roll 36.

Spreading fiber bundles while in a resin bath, and across a relatively wide fiber web or span, can present a multitude of difficulties. For example, the resin in the bath can inhibit spreading and the vibration can be disproportionate across a relatively long spreader bar, leading to poor localized spreading across a fiber web. However, the examples below provide for more effective spreading, especially for anti-ballistic fiber bundles in a relatively low viscosity resin bath.

In the example shown in FIG. 2, there is a single, exclusive mechanical vibration device 30 that is arranged to input the mechanical vibration into the spreader bar 26 at the mid-point, represented at P1, between the first and second ends 26a/26b. The input of the mechanical vibration at the mid-point P1 distributes the mechanical vibrations along the spreader bar 26 towards the first and second ends 26a/26b for a relatively uniform vibration profile as a function of position along the spreader bar 26. For example, as a comparison, a vibration input from only one end may produce strong vibration near that end but weak vibration near the other end, resulting in uneven spreading depending on position along the spreader bar.

FIG. 3 and FIG. 4 illustrate further examples. In FIG. 3, there are three mechanical vibration devices 30 located at, respectively, positions P1, P2, and P3. Position P1 is at the mid-point between the first and second ends 26a/26b of the spreader bar 26, and positions P2 and P3 are located near the ends 26a and 26b, respectively. In FIG. 4, the middle mechanical vibration device 30 is excluded such there are only two mechanical vibration devices 30 located at the respective P2 and P3 positions, which are symmetric with respect to the mid-point between the ends 26a/26b. The mounts 27 (not shown) can be repositioned in between the mechanical vibration devices 30 as needed. The use of multiple mechanical vibration devices 30 provides more vibration input into to the spreader bar 26 although, depending on the input positions, the mechanical vibration can cancel and leave vibration “dead spots” along the spreader bar 26.

The spreading using one or more of the mechanical vibration devices 30 can allow for more uniform spreading across the relatively long span S of the spreader bar 26, especially for the spreading of the anti-ballistic fiber bundles 24a in the resin bath 32. For example, in any of the examples herein, the resin bath 32 can be a water based emulsion, such as PRINLIN B7137 HV, having a viscosity of 300-1200 centipoise. This relatively low viscosity, coupled with the example vibrational arrangements disclosed herein, can provide effective spreading and, in turn, the ability to lower areal density of a monolayer and multi-layer laminate, as well lower layer-to-layer weight standard deviation, to improve performance. The improved spreading can also permit the use of heavier fiber bundles to produce lighter weight monolayers than would be possible without the use of the fiber spreader 22 and mechanical vibration device 30. The use of the heavier fiber bundles can facilitate cost reduction without negatively affecting ballistic performance of the final product. The enhanced spreading herein can also permit more effective spreading of difficult-to-spread fiber bundles, such as higher dtex fiber bundles, and a reduction tensioning on the fiber bundles during processing. Higher tensioning is generally needed to enhance spreading; however, the enhanced spearing herein mitigates the need for higher tensioning and can provide higher tolerances to tensioning variations relative to end performance.

The fiber processing system 20 also embodies a method, which can incorporate any of the examples above or portions thereof, for spreading at least one fiber bundle 24a. For example, the method includes moving at least one tensioned fiber bundle 24a, or a web of tensioned fiber bundles 24a as described above, over the radiused surface 28 of the spreader bar 26 and, during the moving, inputting mechanical vibration into the spreader bar 26 at a location, L, between the first and second ends 26a/26b, to transversely spread and flatten the at least one tensioned fiber bundle 24a, or web of fiber bundles 24a, across the span S of the spreader bar 26 in the resin bath 32.

In a further example, the mechanical vibration can be input into the spreader bar 26 at a single, exclusive location between the first and second ends 26a/26b, one example of which is shown in FIG. 2, where the single, exclusive location is at the mid-point P1 between the first and second ends 26a/26b.

In another example, the mechanical vibration is input into the spreader bar 26 at multiple locations along the spreader bar 26, examples of which are shown in FIG. 3 and FIG. 4.

The method can further include inputting the mechanical vibration into the spreader bar 26 to establish a spreader bar vibration frequency of at least 5000 Hz and a spreader bar force of vibration of at least 300 pounds. The frequency and force represent the intensity of the vibration. The force of vibration is the amount of force, in pounds, generated by the vibration of the spreader bar 26. In a further example, the spreader bar vibration frequency is at least 7000 Hz, at least 10000 Hz, at least 15000 Hz, or at least 20000 Hz.

### EXAMPLES

Referring to Table 1 below, multiple vibration trials were conducted over numerous vibration intensities using two different types of vibration devices, Type A Vibrator and Type B Vibrator, at different locations along the spreader bar 26. Position 1 corresponds to P1, Position 2 to P2, and Position 3 to P3.

TABLE 1
Vibration Trial Summary

| | Relative | | | |
|---|---|---|---|---|
| Trial | Vibration Intensity | | | |
| Number | (5 high, 1 low) | Position 1 | Position 2 | Position 3 |
| 1 | 1 | Type A Vibrator | | |
| 2 | 5 | Type A Vibrator | | |
| 3 | 1 | Type B Vibrator | | |
| 4 | 5 | Type B Vibrator | | |
| 5 | 1 | | Type A Vibrator | Type A Vibrator |
| 6 | 3 | | Type A Vibrator | Type A Vibrator |
| 7 | 1 | Type B Vibrator | Type A Vibrator | Type A Vibrator |
| 8 | 2 | Type B Vibrator | Type A Vibrator | Type A Vibrator |

Table 2 below shows the results of Trials 1-8. Measurements of individual bundle widths (perpendicular to the bundle/filament length) were taken from a location at the middle of the spreader bar 26, a location near the end side of the spreader bar 26, and from an intermediate location between the middle and the end. The measurements were then compared to the amount of spreading at the same locations, without any vibration. The percentage values thus represent the difference in spreading relative to no vibration. Values shown as “<0.5%” represent potential anomalies in the data, and may be zero or negative percent. As shown, the vibration generally improved spreading, with single, center-positioned vibrator devices at high vibration intensity providing the highest improvement in spreading.

TABLE 2
Vibration Trial Results

| Trial | Location On Vibration Bar | | |
|---|---|---|---|
| # | Middle | Mid-Side | Side |
| 1 | 13.58% | 13.33% | <0.5% |
| 2 | 22.22% | 17.89% | 13.14% |
| 3 | 9.68% | <0.5% | <0.5% |
| 4 | 25.53% | 19.59% | 7.32% |
| 5 | 11.39% | <0.5% | 10.59% |
| 6 | 4.11% | 3.70% | 10.59% |
| 7 | 21.35% | <0.5% | 6.17% |
| 8 | 14.63% | 9.30% | 3.18% |

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A fiber processing system, comprising:
a fiber spreader including a spreader bar that extends in a lengthwise direction between first and second ends, the spreader bar carrying at least one radiused surface between the first and second ends; and
at least one mechanical vibration device operable to vibrate the spreader bar, the at least one mechanical vibration device being connected to input mechanical vibration into the spreader bar at a location between the first and second ends.

2. The system as recited in claim 1, wherein the at least one mechanical vibration device consists of a single mechanical vibration device.

3. The system as recited in claim 1, wherein the at least one mechanical vibration device consists of a single mechanical vibration device that is connected to input mechanical vibration into the spreader bar at a mid-point of the spreader bar between the first and second ends.

4. The system as recited in claim 1, where the at least one mechanical vibration device includes a plurality of distinct mechanical vibration devices.

5. The system as recited in claim 1, where the at least one mechanical vibration device includes a plurality of distinct mechanical vibration devices connected to input mechanical vibration into the spreader bar at different, discrete locations along the spreader bar.

6. The system as recited in claim 1, wherein at least the spreader bar is submerged in a resin bath, and the at least one radiused surface has a span, S, of one meter or more.

7. The system as recited in claim 6, wherein the resin bath has a viscosity of 300-1200 centipoise.

8. A method for spreading at least one fiber bundle, the method comprising:
moving at least one tensioned fiber bundle over a radiused surface of a spreader bar that extends in a lengthwise direction between first and second ends; and
during the moving, inputting mechanical vibration into the spreader bar at a location between the first and second ends, to transversely spread and flatten the at least one tensioned fiber bundle.

9. The method as recited in claim 8, further comprising inputting the mechanical vibration into the spreader bar at a single, exclusive location between the first and second ends.

10. The method as recited in claim 9, wherein the single, exclusive location is at a mid-point between the first and second ends.

11. The method as recited in claim 8, further comprising inputting the mechanical vibration into the spreader bar at a mid-point between the first and second ends.

12. The method as recited in claim 8, further comprising inputting the mechanical vibration into the spreader bar at multiple locations along the spreader bar.

13. The method as recited in claim 12, wherein the multiple locations along the spreader bar exclude a mid-point of the spreader bar.

14. The method as recited in claim 12, wherein the multiple locations along the spreader bar are symmetric with respect to a mid-point of the spreader bar.

15. The method as recited in claim 8, further comprising inputting the mechanical vibration into the spreader bar to establish a spreader bar vibration frequency of at least 5000 Hz and a spreader bar force of vibration of at least 300 pounds.

16. The method as recited in claim 8, further comprising inputting the mechanical vibration into the spreader bar and establishing a spreader bar vibration frequency of at least 7000 Hz and a spreader bar force of vibration of at least 300 pounds.

17. The method as recited in claim 8, wherein the moving of the at least one tensioned fiber bundle over the radiused surface includes moving a web of side-by-side fiber bundles over a span, S, across the radiused surface.

18. The method as recited in claim 17, wherein the span, S, is one meter or more, and the radiused surface is submerged in a resin bath.

19. The method as recited in claim 18, wherein the resin bath has a viscosity of 300-1200 centipoise.
